(19) United States
(12) Patent Application Publication
(10) Pub. No.: US 2026/0081888 A1
(43) Pub. Date: Mar. 19, 2026

(54) Dynamic Location-Based Communication Groups

(71) Applicant: ZEBRA TECHNOLOGIES CORPORATION, Lincolinshire, IL (US)

(72) Inventors: David Kreider, Elk River, MN (US); Win Nu Nu Win, Lincolinshire, IL (US); Iouri Tarsounov, Lakewood Ranch, FL (US); Amit Shah, Hoffman Estates, IL (US); Vladyslav Koval, Orlando, FL (US)

(21) Appl. No.: 18/886,642

(22) Filed: Sep. 16, 2024

(51) Int. Cl. H04L 51/222

(52) U.S. Cl. CPC H04L 51/222

(57) ABSTRACT

A method includes: storing (i) a plurality of identifiers, (ii) a group configuration containing a subset of the identifiers, and (iii) a region associated with the group configuration; receiving a location of a client device associated with a first identifier of the plurality of identifiers; determining whether the location of the client device is within the region; based on the determination, updating the subset of identifiers in the group configuration; and transmitting group update data to the client device according to the updated subset of identifiers in the group configuration.

### BACKGROUND

In some communication services, such as instant messaging applications, groups of users can be defined, such that a message sent to the group (e.g., by any user in the group) is delivered to every member of the group. Such groups can be used to disseminate various types of information, and a given user can be a member of multiple groups, e.g., to receive information of different types. The information transmitted through such groups may, however, be redundant and/or irrelevant under some conditions, leading to inefficient use of networking and/or other computational resources.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a communication system.

FIG. 2 is a flowchart of a method for dynamic location-based communication group handling.

FIG. 3 is a diagram illustrating group configuration, site, and account data used in performing the method of FIG. 2.

FIG. 4 is a diagram illustrating successive performances of blocks 210 to 225 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method including: storing (i) a plurality of identifiers, (ii) a group configuration containing a subset of the identifiers, and (iii) a region associated with the group configuration; receiving a location of a client device associated with a first identifier of the plurality of identifiers; determining whether the location of the client device is within the region; based on the determination, updating the subset of identifiers in the group configuration; and transmitting group update data to the client device according to the updated subset of identifiers in the group configuration.

Additional examples disclosed herein are directed to a computing device, comprising: a memory storing (i) a plurality of identifiers, (ii) a group configuration containing a subset of the identifiers, and (iii) a region associated with the group configuration; a communication interface; and a processor configured to: receive, via the communication interface, a location of a client device associated with a first identifier of the plurality of identifiers; determine whether the location of the client device is within the region; based on the determination, update the subset of identifiers in the group configuration; and transmit group update data to the client device according to the updated subset of identifiers in the group configuration.

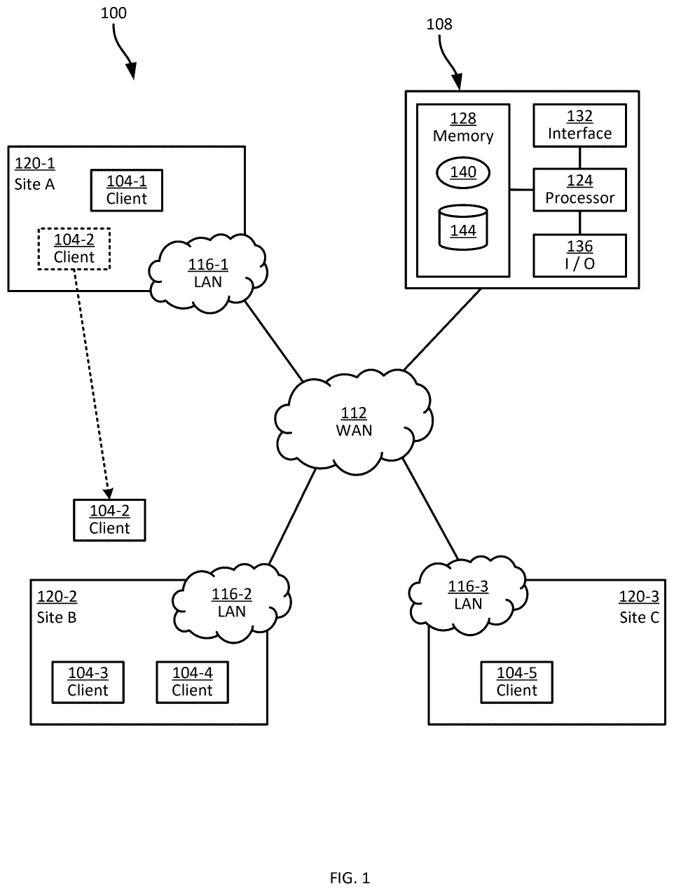

FIG. 1 illustrates a communication system 100 configured to facilitate communication between a plurality of client devices, five examples of which—client devices 104-1, 104-2, 104-3, 104-4, and 104-5, referred to collectively as the client devices 104, and generically as a client device 104—are illustrated. Similar nomenclature (e.g., a leading reference number followed by a hyphenated suffix number) is also used for other elements discussed herein. The system 100 may include fewer than the five client devices 104 illustrated in some examples, or may include more than five client devices (e.g., including hundreds or thousands of client devices 104). Each client device 104 can be any of a wide variety of computing devices with wired or wireless communications capabilities, including mobile computers, wearable computers, smartphones, desktop computers, and the like. Each client device 104 can execute a communications application, e.g., an instant messaging application or the like, facilitating the exchange of one or more of messages (e.g., including text and/or images), file transfers, real-time communications such as voice and/or video calls, and the like, with other client devices 104.

The communications application executed by each client device 104 can be configured to establish a connection between that client device 104 and a server 108, to send and receive communications to and from other client devices 104. For example, a given client device 104 can be configured to connect to a wide-area network (WAN) 112 (e.g., including any suitable combination of cellular networks and/or wired wide-area networks), to which the server 108 is connected. The client devices 104 can also establish connections with one or more local area networks (LANs) 116 (four example LANs 116-1, 116-2, 116-3, and 116-4 are shown in FIG. 1, though it will be understood that the system 100 can include fewer LANs or more LANs in other examples). The LANs 116 can, in turn, be connected with the WAN 112 and thus permit communications between the devices 104 and the server 108.

The communications application executed by the client devices 104, and for which the server 108 can be configured to route messages between client devices 104, can permit the generation of communication groups. For example, each client device 104 can be associated with one of a plurality of accounts (e.g., with an account being associated with an individual user of a client device 104). The association between accounts and client devices 104 need not be fixed. That is, a given user can log into or out of different client devices 104. However, for clarity of illustration, client devices 104 and user accounts are described below as being persistently linked to one another, such that a given client device 104 is a proxy for a particular account. The server 108 can maintain one or more group configurations, e.g., including a group name and/or another group identifier, and containing a subset of the accounts in the system 100.

Client devices 104 that are members of a given group can send messages to the group (e.g., addressed to the group identifier), and the server 108 can be configured to deliver such messages to every member of the group. In other words, the group configurations facilitate one-to-many messaging between certain subsets of the client devices 104 in the system 100. Each client device 104 can be provided with group configuration data for any groups of which the account associated with that client device 104 is a member. The group configuration data provided to a client device 104 can permit, for example, the client device 104 to display the group identifier as a selectable addressee for messages.

In the system 100, the client devices 104 can be associated with one or more of a plurality of sites 120, of which three examples 120-1, 120-2, and 120-3 are shown (though it will be understood that the system 100 can include fewer than three, or more than three, sites in other examples). The sites 120 can be facilities such as retail stores, warehouses, healthcare facilities, or the like. That is, the sites 120 can be physically distinct buildings or collections of buildings, e.g., operated by a common entity or by associated entities. In other examples, the sites 120 can include parcels of land, municipalities, infrastructural elements such as pipelines, or the like. In other words, each site 120 has a particular physical location, distinct from or at least partially distinct from (e.g., if partially overlapping with) the locations of the other sites 120.

The users of the client devices 104 can be associated with one or more of the sites 120, e.g., as employees, contractors, or the like, of the operating entity mentioned above. For example, a user of the client device 104-1 can be assigned to perform tasks at the site 120-1, while a user of the client device 104-5 can be assigned to perform tasks at the site 120-3. Communication groups managed by the server 108 can be configured to include the accounts of users assigned to a given site 120, e.g., to disseminate information relevant to that site 120. For example, a communication group corresponding to the site 120-2 can include the accounts corresponding to the client devices 104-3 and 104-4, and can be used to provide information to the client devices 104-3 and 104-4 concerning emergency alerts, procedural instructions, tasks assignments, or the like, that are relevant to the site 120. In some examples, further communication groups can include some of the accounts assigned to a given site 120 but not others. For example, one communication group at a healthcare site 120 can include the accounts of each member of the site's nursing staff, while another communication group at the same healthcare site can include the accounts of each member of the site's maintenance staff.

Certain client devices 104 and/or the users of such client devices 104 may have transient associations with one or more of the sites 120. For example, the client device 104-2 can be operated by a regional manager, a member of a region-wide maintenance crew, or the like. In other words, the client device 104-2 may travel between two or more of the sites 120. Depending on the current geographic location of the client device 104-2, different types of information may be relevant to the user of the client device 104-2. For example, the client device 120-1 can be added to one or more groups used to disseminate information relevant to the site 120-1. While the client device is located at the site 120-1, the information disseminated via those groups is likely to be relevant to the client device 104-2. However, when the client device 104-2 departs the site 120-1 (e.g., shown as a dashed line extending from the dashed version of the client device 104-2, towards a solid version of the client device 104-2 near the site 120-2), the information disseminated via those groups is less likely to remain relevant to the client device 104-2. Further, if the client device 120-2 travels to the site 120-2, information disseminated via one or more groups associated with the site 120-2 may be relevant to the client device 120-2, but the client device 120-2, not being a member of those groups, may not receive such information.

In other words, different information, circulated via different communication groups, may be relevant to a given client device 104 depending on the location of that client device 104. The server 108, as described below, is configured to dynamically update the membership of communication groups, e.g., based on reported geographical locations from the client devices 104. The dynamic, automated updating of communication group memberships improves the functionality of the server 108 by permitting the server 108 to perform functionality that otherwise involves ad-hoc, manual editing of group memberships by an administrator and/or individual users of the client devices 104, if group memberships are updated at all. Some sites may include hundreds or thousands of client devices 104, and a plurality of sites that at least certain of client devices 104 travel between may therefore encompass many thousands of client devices 104. Manual management of communication groups may therefore be error prone and prohibitively costly. Reliance on manual updates to the communication groups may further introduce delays (e.g., of hours or longer periods) between the physical movements of client devices 104 and the reflection of those physical movements in communication group membership. During such delays, the configuration of communication groups may therefore be out of alignment with the locations of the client devices 104, leading to the delivery of irrelevant communications and/or the omission of relevant communications.

Certain internal components of the server 108 are illustrated in FIG. 1, including a processor 124, such as a central processing unit (CPU), graphics processing unit (GPU) or the like, connected with a non-transitory computer readable medium such as a memory 128. The processor 124 and the memory 128 are implemented as one or more integrated circuits (ICs). The server 108 also includes a communications interface 132 enabling communication between the server 108 and other computing devices, including the client devices 104, via the networks 112 and 116. The interface 132 can therefore include one or more network interface controllers (NICs) or the like.

The server 108 can include an input/output assembly 136, e.g., including one or more of a display, a keyboard, a mouse, a touch screen, or the like. The I/O assembly 136 is configured to receive input, e.g., from an operator of the server 108, and provide data representing the input to the processor 124, as well as to receive output data from the processor 124 and render the output data, e.g., graphically on a display. In other examples, the I/O assembly 136 can be omitted, and input and output data can be received from, and sent to, a remotely operated terminal via the network 112.

The memory 128 stores a plurality of instructions executable by the processor 124, e.g., in the form of one or more applications, including a communication group handling application 140. The memory 128 can store a variety of other applications not shown in FIG. 1, including for example an application executable by the processor 124 to route messages between the client devices 104 based on the communication groups. The application 140, when executed by the processor 124, configures the server 108 to monitor geographical locations reported by the client devices 104, and to dynamically add and remove accounts to communication groups based on the monitored locations. The server 108 is also configured to deploy updated group definitions to the client devices 104. In some examples, the functionality of the application 140 can be implemented in hardware, e.g., as a field-programmable gate array (FPGA), and application-specific integrated circuit (ASIC), or the like.

The memory 128 also stores a repository 144 containing account records corresponding to the accounts associated with the client devices 104, as well as group configurations. The repository 144 can also contain geographic regions associated with the group configurations, and used for dynamic updating of the group configurations. In some examples, the repository 144 can include site records corresponding to the sites 120, and containing the geographic regions. The repository 144 can be implemented as two or more distinct repositories in other examples, e.g., storing account records separately from group configurations. In further examples, the repository 144 can be accessible to the server 108, but stored remotely from the server 108.

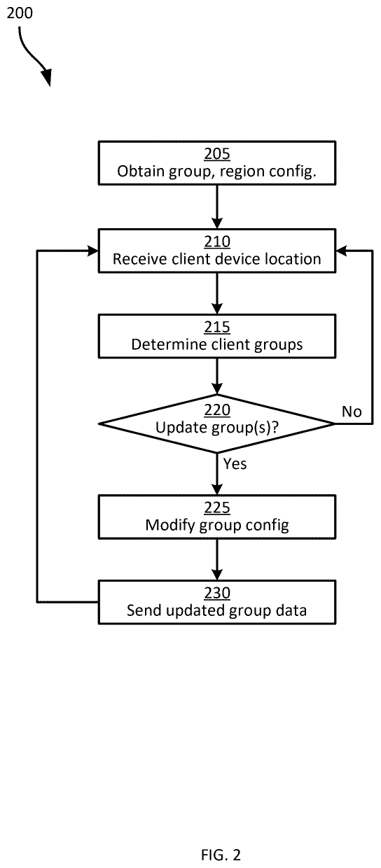

Turning to FIG. 2, a method 200 of dynamic location-based communication group handling is illustrated. The method 200 is described below in conjunction with its example performance in the system 100, e.g., by the server 108 via execution of the application 140.

At block 205, the server 108 is configured to obtain one or more group configurations corresponding to one or more communication groups, and one or more geographic regions associated with the group configurations. Some groups may be associated with more than one geographic region, while other groups may have no associations with geographic regions. The group configurations and geographic regions can be obtained via retrieval from the repository 144, for example.

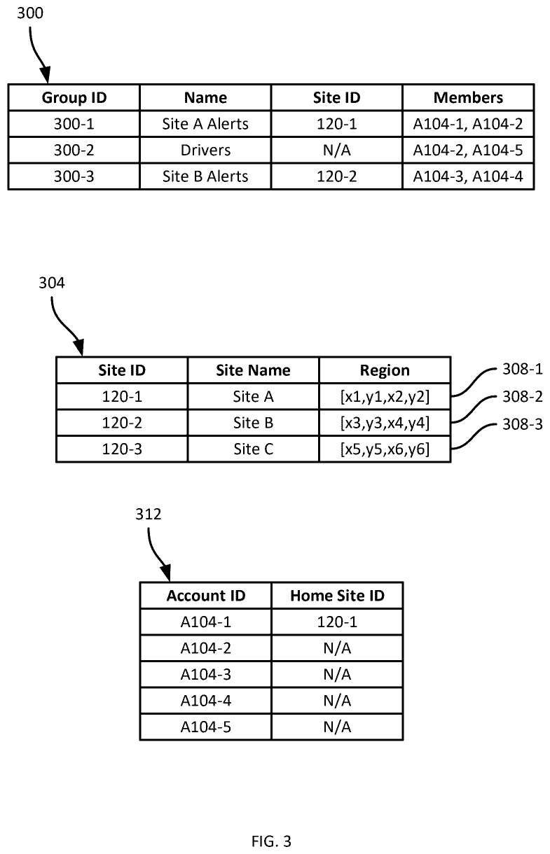

Referring to FIG. 3, example contents of the repository 144 is illustrated, which can be accessed at block 205. The repository 144 can include a plurality of group configuration records 300, which may also be referred to simply as group configurations. Each group configuration includes a group identifier (300-1, 300-2, and 300-3, in this example), and a subset of account identifiers, or members, which in this case are represented by identifiers of the client devices 104 preceded by the letter “A”. In the illustrated example, the group configuration 300-1 lists as members the accounts A104-1 and A104-2, the group configuration 300-2 lists as members the accounts A104-2 and A104-5, and the group configuration 300-3 lists as members the devices A104-3 and A104-4. The repository 144 can contain fewer than three, or more than three, group configurations 300 in other examples. The creation and deletion of group configurations 300 can be performed by an administrator, e.g., an operator of the server 108 or the like. The membership of each group configuration 300 can be manually initialized by such an administrator, or can be populated automatically by the server 108 via performance of the method 200, as well as periodically updated via performance of the method 200.

Each group configuration 300 can also include a name, e.g., a display name to be presented at the client devices 104 that are members of the group. In some examples, however, the group names can be omitted. Each group configuration 300 is also associated with a geographic region. In some examples, the geographic regions can be contained in the group configurations 300. In the illustrated example, the geographic regions are contained in site records 304, each of which includes a site identifier, and one or more geographic regions 308. A group configuration 300 can be made location-invariant (e.g., exempt from the dynamic update functionality described herein) by omitting a geographic region from that group configuration 300.

In this example, each of the sites 120-1, 120-2, and 120-3 are associated with respective regions 308-1, 308-2, and 308-3. The regions 308 can be defined using various formats, including geospatial file formats such as Geographic JavaScript Object Notation (GeoJSON), shapefiles, or the like. In the illustrated example, the regions are rectangular and are defined by pairs of coordinates (e.g., with x1, y1 being a first latitude and longitude, and x2, y2 being a second latitude and longitude). The regions can also be defined by sets of coordinates defining corners of a rectangular region, by coordinates defining a center of a circular region and a radius of the region, or by a polygon with a plurality of vertices (e.g., three or more vertices) defined by coordinate pairs, in other examples.

Associations between group configurations 300 and regions 308 are established via the storage, in each group configuration, of one or more site identifiers. The group configuration 300-1, for example, includes the site identifier “120-1”, which associates the group configuration 300-1 with the region 308-1 (specified in the site record 304 corresponding to the site identifier 120-1). In this example, a group configuration can be made location-invariant by omitting site identifiers, as shown for the group configuration 300-2. A group configuration 300 can also include more than one site identifier, in some examples, thus associating that group configuration 300 with more than one geographic region.

The repository 144 can also contain a plurality of account records 312, e.g., each containing an account identifier (e.g., A104-1 being the account corresponding to the client device 104-1). The account records 312 can include a variety of other information, such as user names, roles, network access levels, and the like. In some examples, as shown in FIG. 3, some account records 312 can include a site identifier, e.g., indicating a “home” site 120 for the corresponding account record 312. Any home site identifier(s) associated with an account record 312 can configure the server 108 to retain the corresponding account record as a member of any group configurations 300 associated with the home site, regardless of the location of the matching client device 104. The account A104-1, in this example, will therefore remain a member of the group configuration 300-1 (associated with the site 120-1) regardless of the location of the client device 104-1.

Returning to FIG. 2, at block 210, the server 108 is configured to receive a location of a client device 104. Block 210 can be performed multiple times, not necessarily simultaneously, for any number of client devices 104. For example, each client device 104 can be configured to periodically report its current location (e.g., in the form of global positioning system (GPS)-derived coordinates or the like) to the server 108. The client devices 104 can be configured to report their locations during certain portions of the day, for example, such as during work hours, and to disable location reporting outside those portions of the day.

At block 215, the server 108 is configured to determine group membership for the client device 104 whose location was received at block 210, at least by determining whether the location of a given client device 104 received at block 210 is within the geographic region(s) 308 associated with any group configurations 300. For example, the server 108 can be configured to retrieve each geographic region 308, and determine whether the client device location is within any of the regions. When the location is within a given region 308, the server 108 can retrieve any group configurations associated with the site identifier corresponding to the matching region 308. The server 108 can also determine whether the client device 104 has a home site, and if a home site is specified for the client device 104, the server 108 can retrieve any group configurations associated with that site 120. Group configurations such as the group configuration 300-2 are omitted from the processing described herein, as the group configuration 300-2 has no associated site identifier (and therefore no associated geographic region).

At block 220, the server 108 is configured to determine whether to update any group configurations 300 based on the determination at block 215. For example, the server 108 can determine whether the group membership determined at block 215 for the client device 104 is different from the existing group membership for that device 104. When the determination at block 220 is negative, indicating that the client device 104 (that is, its associated account A104) is already a member of each group determined at block 215, and is not a member of any groups not determined at block 215), the server 108 can return to block 210 to await the next location report.

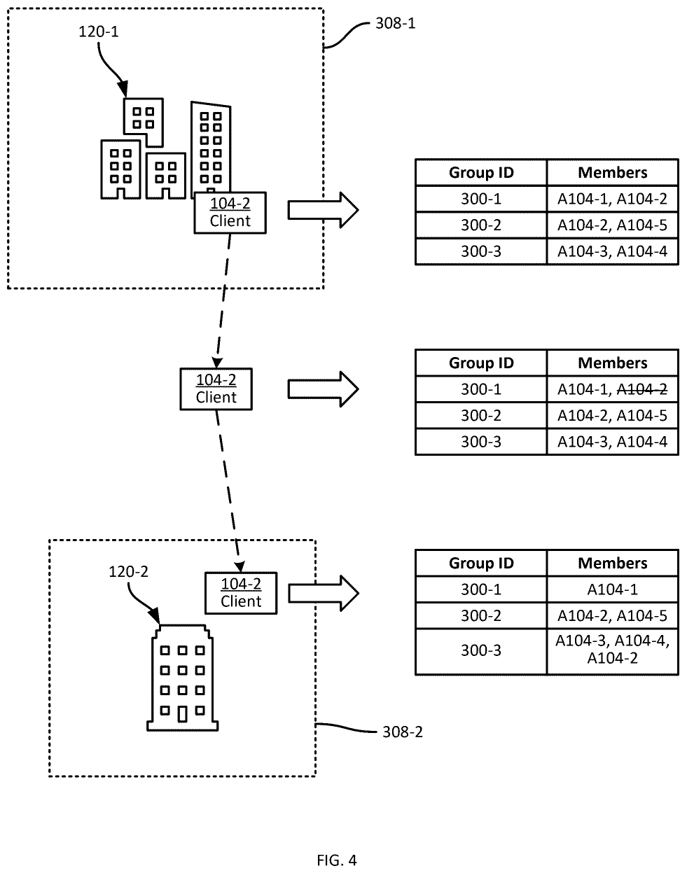

When the determination at block 220 is affirmative, e.g., indicating that the client device 104 is not currently a member of a group determined at block 215, and/or is a member of a group not determined at block 215, the server 108 proceeds to block 225. At block 225, the server 108 is configured to modify the relevant group configurations 300. For example, turning to FIG. 4, the outcomes of three example performances of blocks 210 to 215 (and in some cases, 225) are shown. When the client device 104-2 is within the region 308-1, at block 215 the server 108 determines that the account A104-2 associated with the client device 104-2 should be a member of the group configuration 300-1. As seen in FIG. 3 and reproduced in FIG. 4, the group configuration 300-1 already includes the account A104-2, and the determination at block 220 is therefore negative.

When the client device 104-2 leaves the region 308-1, but has not yet entered another region 308, the server 108 determines that the account A104-2 should not be a member of any group aside from the location-invariant group configuration 300-2. At block 220, the determination is therefore affirmative, and at block 225, the server 108 removes the account A104-2 from the group configuration 300-1, as shown in the middle portion of FIG. 4.

When the client device 104-2 enters the region 308-2, as shown in the lower portion of FIG. 4, the server 108 determines at block 215 that the account A104-2 should be a member of the group configuration 300-3. The determination at block 220 is therefore affirmative, because the account A104-2 was not already a member of the group configuration 300-3. At block 325, the server 108 therefore updates the group configuration 300-3 to include the account identifier A104-2.

Returning to FIG. 2, at block 230, following one or more modifications to the group configurations 300, the server 108 can be configured to send group update data to affected client devices 104, according to the updated group configurations 300. For example, when the account A104-2 is removed from the group configuration 300-1, the server 108-1 can send an instruction to the client device 104-1 to discard locally-stored data such as an identifier of the group configuration 300-1. When the client device 104-1 discards the identifier, the group configuration 300-1 may no longer be presented to an operator of the client device 104-2 as an available addressee for messages, and message history for the group configuration 300-1 may no longer be stored at the client device 104-2. When the server 108 adds the account A104-2 to the group configuration 300-3, the server 108 can send update data to the client device 104-2 including an updated group list, e.g., including an identifier of the group configuration 300-3, and optionally message history for the group configuration 300-3.

As will be apparent from the discussion above, the server 108 can therefore automatically detect when group membership has ceased to be relevant for a device, or has become relevant for the device, and can dynamically update group configurations according to such detections. As a result, the delivery of relevant information to each device is maintained, while the delivery of irrelevant information to the devices is mitigated.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
storing (i) a plurality of identifiers, (ii) a group configuration containing a subset of the identifiers, and (iii) a region associated with the group configuration;
receiving a location of a client device associated with a first identifier of the plurality of identifiers;
determining whether the location of the client device is within the region;
based on the determination, updating the subset of identifiers in the group configuration; and
transmitting group update data to the client device according to the updated subset of identifiers in the group configuration.

2. The method of claim 1, further comprising:
receiving a message including an identifier corresponding to the group configuration; and
routing the message to respective client devices associated with each of the updated subset of identifiers.

3. The method of claim 1, wherein updating the subset of identifiers in the group configuration includes:
when the first identifier is included in the subset of identifiers and the location of the client device is outside the region, removing the first identifier from the subset of identifiers.

4. The method of claim 3, wherein transmitting the group update data includes transmitting an instruction to the client device to discard an identifier corresponding to the group configuration.

5. The method of claim 1, wherein updating the subset of identifiers in the group configuration includes:
when the first identifier is not included in the subset of identifiers and the location of the client device is within the region, adding the first identifier to the subset of identifiers.

6. The method of claim 5, wherein transmitting the group update data includes transmitting, to the client device, an identifier corresponding to the group configuration.

7. The method of claim 1, further comprising:
storing a site record including a site identifier and the region; and
storing the site identifier in association with the group configuration;
when the location of the client device is within the region, identifying the group configuration for updating based on the site identifier.

8. The method of claim 1, further comprising:
storing, in association with a second identifier of the plurality of identifiers, an association with the region; and
maintaining the second identifier in the subset of the identifiers of the group configuration independently of a location of a second client device associated with the second identifier.

9. A computing device, comprising:
a memory storing (i) a plurality of identifiers, (ii) a group configuration containing a subset of the identifiers, and (iii) a region associated with the group configuration;
a communication interface; and
a processor configured to:
receive, via the communication interface, a location of a client device associated with a first identifier of the plurality of identifiers;
determine whether the location of the client device is within the region;
based on the determination, update the subset of identifiers in the group configuration; and
transmit group update data to the client device according to the updated subset of identifiers in the group configuration.

10. The computing device of claim 9, wherein the processor is further configured to:
receive a message including an identifier corresponding to the group configuration; and
route the message to respective client devices associated with each of the updated subset of identifiers.

11. The computing device of claim 9, wherein the processor is configured to update the subset of identifiers in the group configuration by:
when the first identifier is included in the subset of identifiers and the location of the client device is outside the region, removing the first identifier from the subset of identifiers.

12. The computing device of claim 11, wherein the processor is configured to transmit the group update data by transmitting an instruction to the client device to discard an identifier corresponding to the group configuration.

13. The computing device of claim 9, wherein the processor is configured to update the subset of identifiers in the group configuration by:
when the first identifier is not included in the subset of identifiers and the location of the client device is within the region, adding the first identifier to the subset of identifiers.

14. The computing device of claim 13, wherein the processor is configured to transmit the group update data by transmitting, to the client device, an identifier corresponding to the group configuration.

15. The computing device of claim 9, wherein the processor is further configured to:
store a site record including a site identifier and the region; and
store the site identifier in association with the group configuration; and
when the location of the client device is within the region, identify the group configuration for updating based on the site identifier.

16. The computing device of claim 9, wherein the processor is further configured to:
store, in association with a second identifier of the plurality of identifiers, an association with the region; and
maintain the second identifier in the subset of the identifiers of the group configuration independently of a location of a second client device associated with the second identifier.
